(19) United States
(12) Patent Application Publication
(10) Pub. No.: US 2013/0176900 A1
(43) Pub. Date: Jul. 11, 2013

(54) Discovery in MoCA Networks

(71) Applicant: Sagar JOGADHENU, San Diego, CA (US)

(72) Inventor: Sagar JOGADHENU, San Diego, CA (US)

(73) Assignee: ENTROPIC COMMUNICATIONS, INC., San Diego, CA (US)

(21) Appl. No.: 13/343,904

(22) Filed: Jan. 5, 2012

(51) Int. Cl. H04L 12/28

(52) U.S. Cl. 370/255

(57) ABSTRACT

Methods, apparatuses, systems, and computer program products that may be based on MoCA protocols for discovering MoCA devices in a MoCA network include causing a first MoCA device to periodically send the device specific information to a second MoCA device in the MoCA network. The information may be sent, for example in a link-layer discovery protocol (LLDP) message in which the information is encoded in a type-length value (TLV) message. The information may include a MAC address of the first MoCA device, an IP address of the first MoCA device, vendor identification information, hardware identification information, hardware version information, software identification information, a software version, a name of the first MoCA device, a location of the first MoCA device, a MoCA node assigned to the first MoCA device, or the like.

### FIELD

The disclosed methods, apparatuses, systems, and computer program products relate to networks of the type that may be based on MoCA protocols, and more particularly to methods, apparatuses, systems, and computer program products for use in networks of the type described for discovering MoCA devices therein.

### BACKGROUND

As an ever-increasing number of multimedia applications become available, networks, especially home entertainment networks, must be able to accommodate the applications with little or no interruptions. Consumers expect to be able to watch digitally recorded video (DVR) TV shows, access video on demand (VOD) services, stream music from their personal computers, play interactive games on the Internet, and more. The consumers expect to enjoy these services in real time, virtually from any room in the home.

A typical home installation of a single-cable system is shown in FIG. 1 as an illustrative example of a home network environment 10. The environment 10 illustrates a home installation based on a MoCA architecture. MoCA® is a service mark of Multimedia Over Coax Alliance, Inc. of San Ramon, Calif. The Multimedia Over Coax Alliance (MoCA) is a trade group that promotes standards relating to software protocols, hardware topologies, interconnections of consumer electronics devices, and networking thereof. As the MoCA standards develop, various names have emerged to describe the software protocols, hardware topologies, interconnections, and networks that adhere to particular MoCA standards versions, such as “MoCA 1.1,” “MoCA 2.0,” and so forth. Thus, unless otherwise specifically noted, the term “MoCA” is used herein to designate software protocols, hardware topologies, interconnections of consumer electronics devices, and networks that substantially meet a past, present, or future MoCA standard for the purpose or purposes stated or implied herein.

The home network environment 10 is an illustrative example of one of many such environments to which the disclosed methods, apparatuses, systems, and computer program products pertain. It should be noted that although a home network environment 10 is shown for illustration, the methods, apparatuses, systems, and computer program products described herein may be employed in a myriad of other installation locations. One example may include an apartment complex in which a number of dwellings in multi building complex may be included in a single network. Another example may include a business building in which a network may be employed in a number of offices. Other examples are manifold.

The home network environment 10 includes a digital video recorder 12, a first set-top box having an integrated receiver/decoder 14 (IRD/STB), and a television (TV) 16 having an associated second set-top box 18. The TV 16 may also have an associated internet streaming video receiver (ISVR) 20, such as an ISVR device available from Roku, Inc., of Saratoga, Calif.

The home network environment 10 example also includes three computers, a first personal computer (PC1) 22, a second personal computer (PC2) 24, and a laptop computer 26. The PC2 24 and laptop computer 26 are connected to a broadband modem/router 28, which provides broadband signals thereto as well as wirelessly to a switch 30 over a wireless link 32. The wireless signals 32 may be, for example, an Ethernet link that supplies digital data or video content for use by the PC1 22 and ISVR 20.

In the home network environment 10 example, satellite signals are received by the DVR 12, the STB 18, and the IRD/STB 14 by respective satellite receiving equipment units 38, 40, and 42, respectively. Although three separate satellite receiving equipment units 38, 40, and 42 are shown, the signals may be derived from a single satellite dish receiver and distributed on a single coaxial cable to the various consumer devices in the home. Additionally, although satellite dish receivers are illustrated, the signals may be derived from a cable distribution system, or the like. Moreover, the signals may be derived from fiber optic networks, such as the VERIZON FiOS® system, or the like. (VERIZON FiOS® is a registered service mark of Verizon Trademark Services, LLC, of Arlington, Va.)

Finally, the various consumer devices described above are networked together in a MoCA architecture by data link-layer bridges L2₁ 46, L2₂ 48, and L2₃ 50. (The data link layer is defined in the seven-layer Open Systems Interconnection model (OSI model) of the International Organization for Standardization.) Typically, the link-layer bridges designated by L2_{X} are supplied and controlled by the service provider via control signals downloaded, for instance, from a satellite link.

The link-layer bridges L2₁ 46, L2₂ 48, and L2₃ 50 are interconnected with each other and with the IRD/STB 14 in a closed network, indicated by the heavy interconnection lines 52, 54, 56, 58 and 60. The closed network is not modifiable by the user, and is in distinction to the open network, which is user modifiable and which comprises the interconnections of the consumer devices described above.

Each of the data link-layer bridges L2₁ 46, L2₂ 48, and L2₃ 50 is associated with one or more consumer devices. For example, data link-layer bridge L2₁ 46 is associated with the DVR 12. The data link-layer bridge L2₂ 48 is associated with the switch 30. The data link-layer bridge L2₃ 50 is associated with the broadband modem/router 28. In addition, each of the data link-layer bridges L2₁ 46, L2₂ 48, and L2₃ 50 is connected to the IRD/STB 14. The data link-layer bridge L2₁ 46 is connected to the data link-layer bridge L2₂ 48. The data link-layer bridge L2₂ 48 is connected to the data link-layer 2 device L2₃ 50. Consequently, each of the data link-layer bridges L2₁ 46, L2₂ 48, and L2₃ 50 can communicate with each other. Moreover, because each of the data link-layer bridges L2₁ 46, L2₂ 48, and L2₃ 50 is associated with one or more of the consumer devices, the closed network enables the consumer devices to communicate with each other according to the MoCA architecture created thereby.

The link-layer bridges L2₁ 46, L2₂ 48, and L2₃ 50 belong exclusively to the closed network, however, they can be used to extend the open network. This means the link-layer bridges L2₁ 46, L2₂ 48, and L2₃ 50 are controlled by the service provider. Control here includes management operations such as network configuration, software upgrades, Parameterized Qualify of Service (PQoS), PQoS flow setup and tear down, and the like.

Two potential scenarios exist. According to the first scenario, the service provider may set up the network such that the closed and open networks operate seamlessly as a single network. Each of the nodes in the network has a unique IP address, and any node can communicate with any other node via a TCP/IP telnet-type application. One Device (either an STB or a router) assigns the unique IP address. However, a problem exists in the discovery of the MoCA nodes, particularly in the performance of certain management operations on the MoCA nodes. For example, if the data link-layer bridge L2₁ 46 were to be removed from the home network environment 10, special procedures may need to be employed to remove the identification of the data link-layer bridge L2₁ 46 from the registers or memories of the remaining data link-layer bridges L2₂ 48, and L2₃ 50. On the other hand, if an additional data link-layer bridge (not shown) were to be added in the home network environment 10, special installation procedures would need to be initiated in order for the additional data link-layer bridge to be recognized.

According to the second, most likely, scenario, the service provider may setup the overall network such that nodes in the open network can use services of the closed network; for example, nodes in the open network can share some MoCA bandwidth of the closed network. However, the devices in the open network do not have the ability to control any of the closed network bridges. Again, a problem exists in the discovery of the data link-layer bridges comprising the MoCA nodes.

In either scenario, the service provider can still reach each STB. Consequently, any STB can potentially control any of the MoCA devices in the network.

It has been proposed to provide a MoCA capability directly in an STB, for example, as a part of a home media center device (HMC). The HMC would then deliver content for every STB. This would eliminate the need to provide a direct satellite link to every STB. An example of a home network environment 11 having a home media center (HMC) 70 and a MoCA-only STB 72 is shown in FIG. 2, to which reference is now additionally made. The home network environment 11 is similar to the home network environment 10 described above with reference to FIG. 1, except for the closed network portion and the replacement of the DVR 12 and satellite receiver 38 with the MoCA-only STB 72. The HMC 70 has its own satellite receiving equipment unit 74.

The closed network of the home network environment 11 example of FIG. 2 includes two data link-layer bridges L2₂ 48, and L2₃ 50. The data link-layer bridge L2₂ 48 is associated with the switch 30. The data link-layer bridge L2₃ 50 is associated with the broadband modem/router 28. In addition, the various MoCA devices are interconnected to enable them to communicate with each other. For example, the MoCA-only STB 72 is connected in the closed network with the HMC 70 by line 78, the data link-layer bridge L2₂ 48 by line 76, and the data link-layer bridge L2₃ 50 by line 80. The HMC 70 is connected to the data link-layer bridge L2₂ 48 by line 82, and the data link-layer bridge L2₃ 50 by line 86. The data link-layer bridge L2₂ 48 is connected to the data link-layer bridge L2₃ 50 by line 84.

Although not fully known at this time, this arrangement might enable the HMC 70 to be a single point at which the content or service provider may control all of the MoCA devices in the network to perform management operations. Nothing would change with respect to the open network devices, however, and the problem of identifying new MoCA devices inserted into or removed from the network would remain.

What is needed are principles, apparatuses, methods, systems, and computer program products that can be used to automatically discover the information pertaining to MoCA devices that are installed into or removed from a MoCA system, including a MoCA home network environment.

### SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

One disclosed embodiment provides a method of discovering information about a first MoCA device in a MoCA network. The method includes causing the first MoCA device to periodically send the information to at least a second MoCA device in the MoCA network and causing the second MoCA device to receive the information. The information may be sent, for example in a link-layer discovery protocol (LLDP) message in which the information is encoded in a type-length value (TLV) message. The information may be sent about every 60 seconds. The information may include vendor identification information of the first MoCA device, hardware identification information of the first MoCA device, hardware version information of the first MoCA device, software identification information of the first MoCA device, a software version of the first MoCA device, a name of the first MoCA device, a location of the first MoCA device, a MoCA node assigned to the first MoCA device, or the like.

Another disclosed embodiment provides a computer program product. The computer program product includes a computer usable medium having a computer readable program code embodied therein. The computer readable program code is adapted to be executed to implement a method for discovering information about a first MoCA node. The method includes repeatedly determining a time period, at the expiration of the time period, causing the first MoCA node to send device specific information about the first MoCA device to at least a second MoCA device in a MoCA network containing the first and second MoCA devices. The method may be repeated in a time period of about 60 seconds. The information may include vendor identification information of the first MoCA device, hardware identification information of the first MoCA device, hardware version information of the first MoCA device, software identification information of the first MoCA device, a software version of the first MoCA device, a name of the first MoCA device, a location of the first MoCA device, a MoCA node assigned to the first MoCA device, or the like.

Another disclosed embodiment provides a network. The network includes a plurality of MoCA devices, at least some of the MoCA devices being adapted to be connected to respective network devices, a link-layer discovery protocol (LLDP) agent associated with one of the plurality of network devices, and a management database. The plurality of MoCA devices each periodically sends device specific information to the LLDP agent. The LLDP agent causes the information sent by the plurality of MoCA devices to be stored in the management database. Thus, information of any of the plurality of MoCA nodes can be discovered from the information in the management database. The may be sent periodically about every 60 seconds in a type-length value (TLV) message in an LLDP message sent to the LLDP agent. The information may include vendor identification information, hardware identification information, hardware version information, software identification information, a software version, a name of a MoCA device, a location of a MoCA device, a MoCA node assigned to the a MoCA device, or the like.

Another disclosed embodiment provides a MoCA node discovery process. The MoCA node discovery process includes determining whether a MoCA node has been linked into a MoCA network, then determining whether the MoCA node has been linked into the MoCA network for the first time. If the determination is that the MoCA node is linked into the network for the first time, setting a time-to-live (TTL) value to zero. If the determination is that the MoCA node is not linked into the network for the first time, determining whether a 60-second timer has expired. If the determination is that the 60-second timer has not expired, repeating the foregoing steps. If the determination is that the 60-second timer has expired, resetting the 60 second timer and encoding and sending a link-layer discovery protocol data unit (LLDPDU) containing device specific information about the MoCA node.

Another disclosed embodiment provides a home entertainment system that includes a plurality of MoCA devices and a plurality of network devices connected to a respective at least some of the MoCA devices. A link-layer discovery protocol (LLDP) agent is provided on one of the network devices with which the MoCA devices communicate. A management database is provided, wherein the LLDP causes device specific information about the MoCA devices to be stored in the management database. Thus, information about any of the plurality of MoCA devices can be discovered from the information in the management database. The MoCA nodes may optionally push the information to the management database or pull at least some of the information from the management database.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 illustrates an example of a home network environment in which the principles, methods, apparatuses, systems, and computer program products described herein may be employed.

FIG. 2 illustrates an example of a home network environment having a home media center (HMC) and a MoCA-only set-top box, in which the principles, methods, apparatuses, systems, and computer program products described herein may be employed.

FIG. 3 is a diagram illustrating an example of a logical device discover mode for a MoCA network.

FIG. 4 is a software flow chart illustrating a detailed discovery process in a MoCA node.

FIG. 5 is a diagram showing the format of a link-layer discovery protocol discovery unit (LLDPDU) packet containing a number of mandatory and optional type-length values (TLVs).

FIG. 6 is a packet diagram showing the format of a type-length value (TLV) encoded message that may be contained in an link-layer discovery protocol discovery unit (LLDPDU) packet.

FIG. 7 is a format of a completed link-layer discovery protocol link-layer discovery protocol (LLDP) Ethernet packet.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

The disclosed principles, methods, apparatuses, systems, and computer program products perform an automatic identification of MoCA devices, such as link-layer bridges, or the like, that are installed or removed in a MoCA network. The identification is accomplished by advertising device specific information about each MoCA node, such as, for example:
its MAC address
its IP address, for example, assigned by a software application, a user, dynamic host configuration protocol (DHCP) operation, or link layer address (LLA) operation
its vendor ID,
its hardware ID
its hardware version
its software ID
its software version
its name (for example, a string of 8 characters
its location, for example, its assigned MoCA node ID
other programmable information

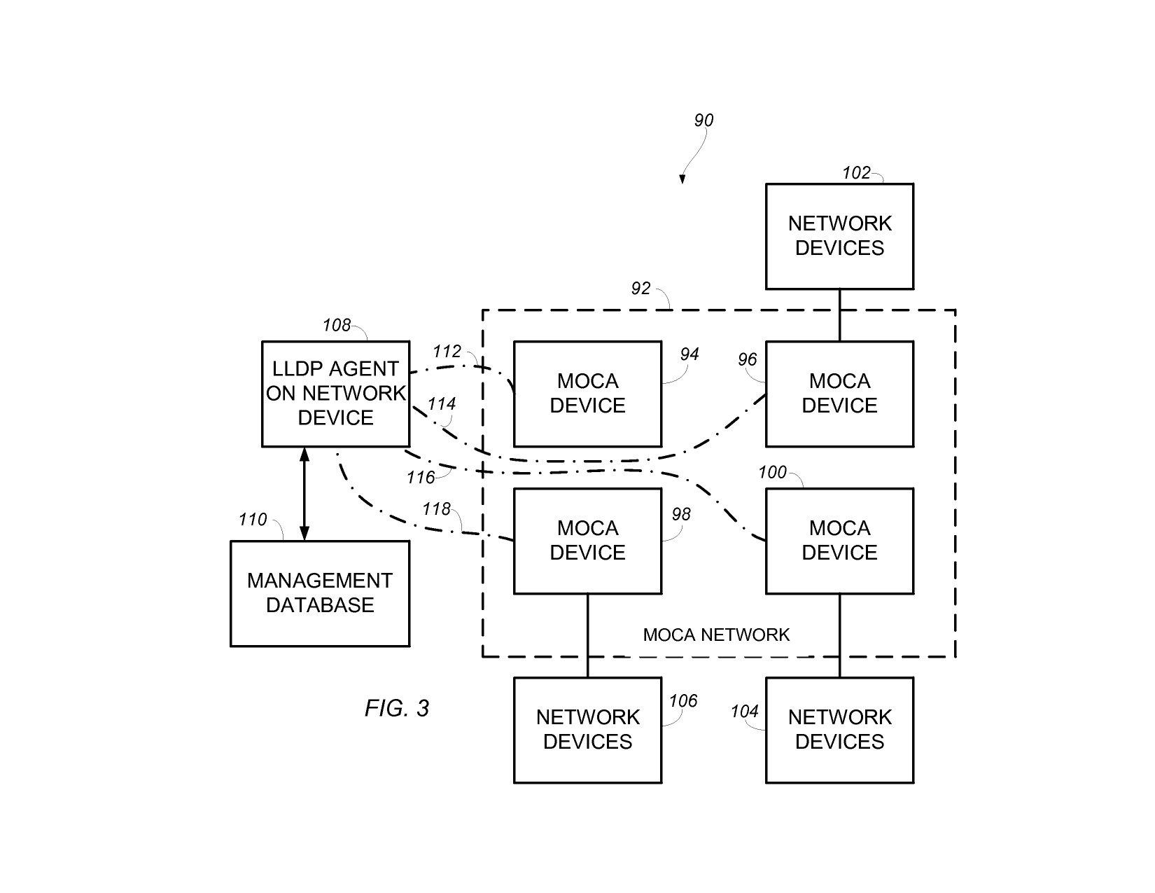

Reference is now additionally made to FIG. 3, which shows a diagram 90 illustrating an example of a logical device discover mode for a MoCA network 92. In the example illustrated, the MoCA network 92 includes four MoCA devices 94, 96, 98, and 100. The MoCA devices 94, 96, 98, and 100 may be link-layer bridges of the type described above. Network devices 102, 104, and 106 are associated with MoCA devices 96 and 100, respectively. The network devices 102, 104, and 106 may be of the type described above, for example, PVRs, STBs, Broadband Modem/Routers, Switches, or the like. A network device 108 is also provided that performs the function of an LLDP agent, which communicates with a management database 110.

Each of the MoCA devices 94, 96, 98, and 100 communicates on respective lines 112, 114, 116, and 118 with the network device 108 on which the LLDP agent is contained. According to various aspects of the methods, apparatuses, systems, and computer program products disclosed herein, the MoCA devices periodically advertise, or push, certain information to the network, using a specified multicast MAC address. One period that may be used, for example, in pushing the information may be every 60 seconds, although other periods may be used depending on the needs of the network. Optionally, MoCA devices in the network may collect and store advertised information from other MoCA devices and can provide the information to the entire MoCA database if requested. Convenient formats for storing the information may be, for example, in the form of a management information base (MIB), or other well-defined structure.

Alternately, the information may be is stored in a specified MoCA node. In this case, an STB has the ability to request, or pull, the information. This may be done, for example, by causing an STB to issue a multicast request for information. The request may specify what information is being requested, and may include a request for the entire discovery MIB from one MOCA node, or any part thereof. In accordance with one aspect, each STB has the ability to query, or pull, the MAC address of the link-layer bridge connected to it. An STB may have the ability to push its IP address to other MOCA devices in the network. In broadcasting its information in a push mode, each MoCA node may multicast the information using a fixed Ethernet multicast destination address (EMDA). Alternatively, in a pull mode, an STB can request information by sending a request packet to a fixed EMDA. All MoCA nodes then respond to this request with either local-only information or the entire discovery MIB. STBs may send a request to the MoCA nodes to a predetermined IP address. The request may contain a mapping of the MoCA node ID or MoCA node MAC address to a unique IP address. A MoCA node whose MAC address or node ID matches the information in the request will update its IP address, and the other MoCA nodes will drop the packet.

Currently, the MoCA standard requires nodes to store up to 64 MAC addresses of devices behind its Ethernet Convergence layer. MoCA devices supplied by Entropic Communications, Inc., for example, store these addresses either as a source address or a destination address in a local content addressable memory (CAM) table. When a packet is received, these devices attempt to match the address of the packet with addresses in the CAM. If no entry is found, the device will create an appropriate source or destination entry in the CAM. This can be used to determine a specific link-layer bridge associated with an STB by mapping a MAC address of an STB to a source MAC address entry into the link-layer bridge.

An STB can send a Query message (multicast Ethernet packet) with its own MAC address and request an associated link-layer bridge: Any MoCA device that finds a MAC address of one or more STBs in its source table responds with query-response that contains its own MAC address. On the other hand, if a MoCA device does not find a MAC address of any other STBs in its source table merely ignores or drops the multicast packet.

Thus, the information may be pushed to the network or pulled from a MoCA device in the network. Additionally, both a push operation may be used in conjunction with a pull operation. The information may be transmitted using a link-layer discover protocol, such as a link-layer discovery protocol (LLDP) established the Institute of Electrical and Electronic Engineers (IEEE), or a link-layer discovery protocol (EDP) established by Entropic Communications, Inc., of San Diego, Calif. An STB may have ability to perform management activity using this protocol.

In operation, each the MoCA devices 94, 96, 98, and 100 periodically sends out the link-layer discovery protocol discovery units (LLDPDUs), sometimes referred to as discovery frames, for example, every 60 seconds. A one link-layer discovery protocol (LLDP) agent software module running on the network device 108 collects all the LLDPDUs, and stores them into the management database 110. The user can then view the database, if desired, to understand the MoCA network structure. The dotted communication lines 112, 114, 116, and 118 provide the path for the LLDPDUs, since the multicast packets will be broadcast to all MoCA nodes. Thus, any network device that connects with any MoCA device can receive the LLDPDUs.

The software of the MoCA nodes integrates the device discovery module in the TCP/IP stack and uses the low-level Ethernet driver to send out the LLDPDUs. The LLDPDUs are sent out to network after a node has joined the network. Therefore, the node has to monitor the MoCA link status. Once the node is linked, it sends out the LLDPDUs. If the LLDPDUs are not sent out, the discovery process is bypassed. The software may be provided as a computer program product that may be contained in the LLDP agent 108 to provide a computer program, which, when executed, causes the processor of the network device to perform the discovery steps described herein.

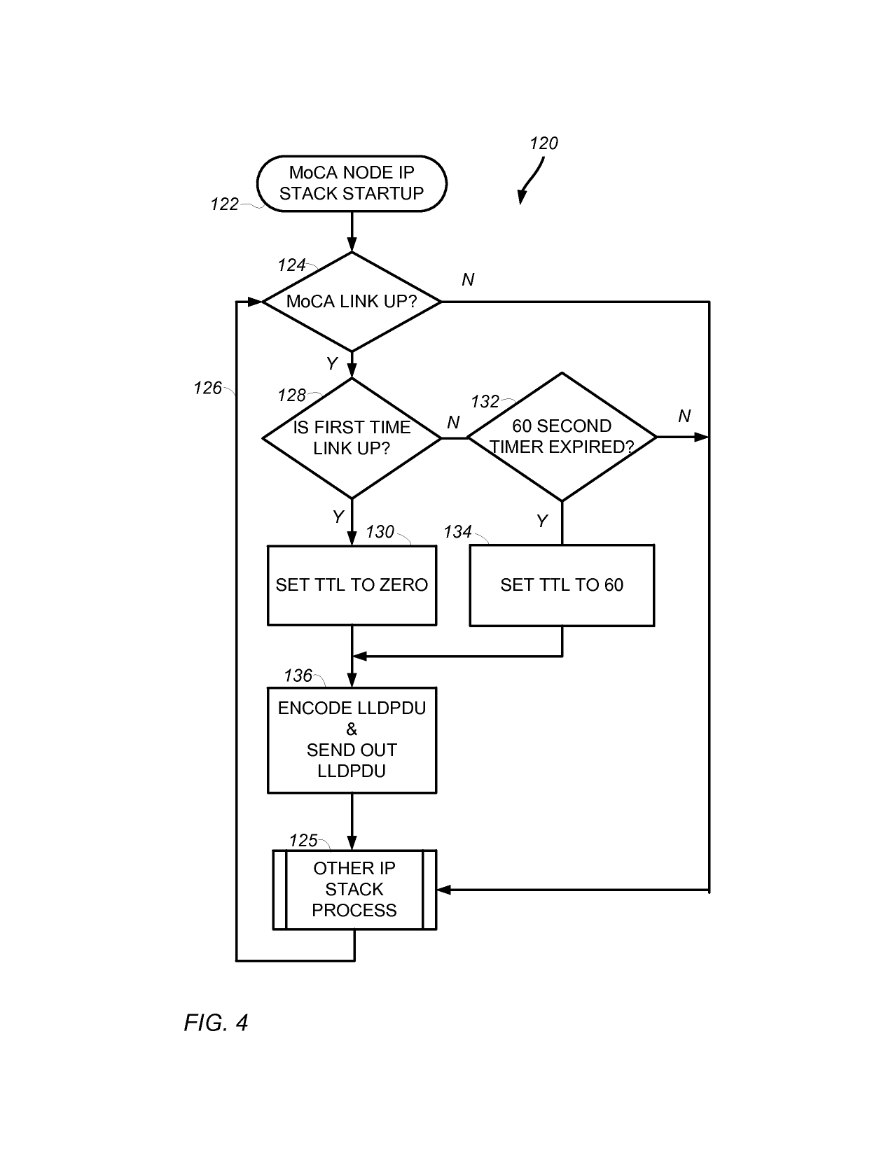

The detailed MoCA node discovery process is described in the flow chart 120 in FIG. 4, to which reference is now additionally made. The IP stack startup discovery process begins 122, and a determination is made whether a MoCA node has been linked up, diamond 124. If no MoCA node has been linked up, a subprocess is performed executing any other IP stack process, box 125, and, thereafter, the process loops, indicated by line 126, back to diamond 124.

On the other hand, if the determination is made indicating that a MoCA node has been liked up, a determination is made as to whether it is the first time for a link up of the MoCA node, diamond 128. If the determination is made that it is the first time for a link up of the MoCA node, the time-to-live (TTL) value is set to zero, box 130. On the other hand, if it is not the first time for a link up of the MoCA node, a determination is made whether the 60-second timer has expired, diamond 132. If the 60-second timer has not expired, the process again loops back to diamond 124. If the 60-second timer has expired, the TTL value is set to 60, box 134, and the main process continues to box 136.

In box 136, the LLDPDU is encoded and sent out. Thereafter, the subprocess is performed executing any other IP stack process, box 125, and the process loops, indicated by line 126, back to diamond 124.

The standard destination address of LLDP protocol is: Multicast address 01-80-C2-00-00-0E, and the standard LLDP Ethertype is 88-CC. For the discovery protocol described herein, the various information to be sent to a multicast address can be encoded in a type-length-value (TLV) element that does affect the spanning tree-protocol. In order to save network bandwidth, all the type link values (TLVs) may be put into one LLDPDU multicast packet.

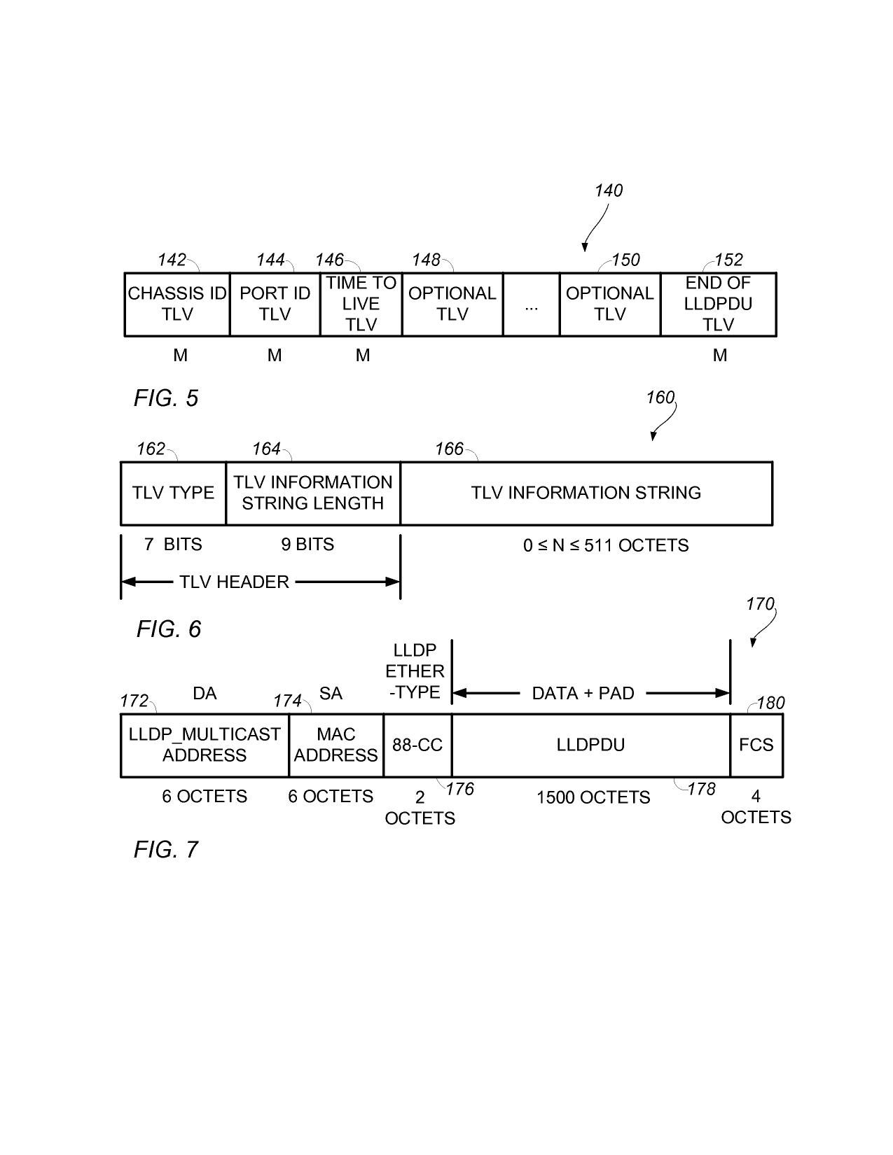

The format of the TLVs of the LLDPDU packet 140 is shown in FIG. 5, to which reference is now additionally made. The LLDPDU packet 140 includes at least the following TLVs: the chassis ID 142, the port id 144, the time-to-live (TTL) 146, optional TLVs 148 . . . 150, and the end of the LLDPDU 152. The symbol “M” adjacent the chassis ID 142, the port id 144, the time-to-live (TTL) 146, and the end of the LLDPDU 152 indicates that those TLVs are mandatory in the LLDPDU packet 140.

The maximum length for the LLDPDU packet 140 is 1500 bytes (the length of an untagged MAC header), and for one TLV the information string should not exceed than 513 octets, including the type and length. The basic TLV format 160 is shown in FIG. 6 to which reference is now additionally made. The TLV header includes the TLV type 162, which may be, for example, 7 bits, and the TLV information string length 164, which may be, for example, 9 bits. The TLV header is followed by the TLV information string 166 itself, which may be of any length between 0 and 511 octets.

A format of one completed LLDP Ethernet packet 170 is shown in FIG. 7, to which reference is now additionally made. The LLDP Ethernet packet 170 has an LLDP multicast address 172, which may be 6 octets in length, followed by a MAC address 174, which may be 6 octets in length. The LLDP Ethertype (88-CC) 176 follows the MAC address 174. The LLDP Ethertype may be 2 octets in length. The data field 178 may contain the data itself and a number of pad bits, and may be 1500 octets in length. Finally a frame-check sequence (FCS) field 180 completes the frame 170. The FCS may be, for example, 4 octets in length,

According to the oritinal IEEE 802.1AB standard, there are four mandatory TLVs that are implemented within one LLDP frame. Those are described in the Table 1 below.

TABLE 1

| TLV type | TLV Name | Usage in LLDPDU |
|---|---|---|
| 0 | End of LLDPDU | Mandatory |
| 1 | Chassis ID | Mandatory |
| 2 | Port ID | Mandatory |
| 3 | Time to Live | Mandatory |
| 4 | Port description | Optional (not implement) |
| 5 | System Name | Optional (not implement) |
| 7 | System Capabilities | Optional (not implement) |
| 8 | Management Address | Optional (not implement) |
| 9-126 | reserved | — |
| 127 | Organizationally | EDP. |
| | Specific TLVs | |

The end of the LLDPDU TLVs is used as the identifier to indicate the end of the LLDPDU. The detailed format of the LLDPDU end is defined in Table 2 below.

TABLE 2

| TLV Type | Length | Pad | Pad |
|---|---|---|---|
| 0 (7-bits) | 0 (9-bits) | ANY | ANY |

For the MoCA end device, there are no need to implement all of the chassis ID information TLVs, and only subtype 5 (the network address) need be implemented. The detailed definition of the chassis ID LLDPDU is described in Table 3 below.

TABLE 3

| TLV Type | Lengt | Subtype | Chassis ID |
|---|---|---|---|
| 1 (7-bits) | 5 (9 - bits) | 5 (network address) | X.X.X.X (IP address) |

Also, there are no need to implement all of the subtypes of the Port ID information TLVs, and only the type of 7 need be implemented as the MoCA node ID. This is shown in the Port ID LLDPDU definitions in Table 4 below.

TABLE 4

| TLV Type | Length | ID subtype | Port ID |
|---|---|---|---|
| 2 (7-bits) | 2 (9 - bits) | 7 | Node ID |

The TTL field contains the integer value in seconds for a timer. If this value is set to zero, it means the LLDP agent (receiving host) must delete the original information for this node after the MoCA node joins the network. The first LLDP packets set the TTL to zero. This deletes the previous information in the agent database. (Consider, for example, the case in which one MoCA node link is down then links up within 60 seconds. The node ID may be changed.) The default TTL May be, for example, 60 seconds or other appropriate, programmable time. The timer of the agent software ages the database if there are no updated LLDP frame received. The TTL LDPDU definitions are set forth in Table 5 below.

| TLV Type | Length | TTL high byte | TTL low byte |
|---|---|---|---|
| 3 (7-bits) | 2 (9 - bits) | 00 | 60 |

For the organizationally Specific TLVs, unified OUI is used to identify the specific protocol. The OUI 00-09-8B allocated from IEEE is used as the identifier for the discover protocol identifier. The definition of the discovery protocol TLVs is shown in Table 5 below, and the discovery protocol TLV information is shown in Table 6 below.

TABLE 5

| | | | OUI- | |
|---|---|---|---|---|
| TLV Type | Length | OUI | Subtype | Information String |
| 127 (7-bits) | TBD (9 - bits) | 00-09-8B | (8-bits) | TBD(0~507 bytes) |

TABLE 6

| OUI | | |
|---|---|---|
| Subtype | Length | Information String |
| 0 | Reserved | — |
| 1 | TBD | End device information including: Mode |
| | | Number; Vendor; Serial Number; Chipset ID; |
| | | HW version; SW version; Device name; |
| 2 | Variable | The network device's addresses those are |
| | | connecting with this MoCA node, (up to 64 MAC |
| | | addresses) |
| 3-255 | Reserved | — |

Table 7 below lists the discovery protocol SUB type 1 TLV information

TABLE 7

| Offset | Length (bytes) | Information string |
|---|---|---|
| 0 | 1 | Master Mode: hostless - 2, hosted - 1 |
| 1 | 4 | Manufactory ID: provide by vendor |
| 5 | 12 | mode number: ASCII string |
| 17 | 4 | Hardware version: provide by vendor |
| 21 | 8 | Mac address: Device Mac Address |
| 29 | 12 | serial number: ASCII string |
| 41 | 4 | Software version: SoC software version. |
| 45 | 4 | Chipset ID: 0x2 0x6 0x1 0x0 means 2610. |

### Table 8. EDP SUB Type 2 TLV Information

Table 8 below lists the discovery protocol SUB type 2 TLV information

TABLE 8

| Offset | Length (bytes) | Information string |
|---|---|---|
| 0 | 1 | How many entries for the source MAC |
| | | address. |
| 1 | 6 | Source Mac address 1 |
| 7 | 6 | Source Mac address 2 |
| 13 | 6 | Source Mac address 3 |
| . . . | . . . | . . . |
| NNNN | 6 | Max Source Mac address items. (84 × 6 = 504 |
| | | Bytes) |

The TLVs may be encoded to the Ethernet packet by an API, such as: Static SYS_UINT32 HSEDP_EncodePDU(SYS_UINT8*pkt, SYS_UINT16 ttl)

This function fetches the device information from the MoCA software, and builds all TLVs into an Ethernet packet. The input parameter of the TTL can be specified when calling the API.

Likewise an API function may be called by the 60 second timer to prepare the LLDP-discover protocol packet, update all of the TLVs, and send the packet out via the Ethernet port. The packet is broadcast to the MoCA network and Ethernet port via management channel. The API may be, for example, SYS_INT32 HsEthDry_PushEDP(void).

The MoCA device discovery protocol is contained in a software module, and is based on the Link Layer Discovery Protocol (LLDP) protocol (IEEE Standard 802.1AB). With the ID and the management IP address of a node, the management devices can easy to communicate with the various MoCA nodes via telnet for management purposes, such as accessing the MoCA shell, configuring devices, monitoring device running statuses, upgrading the firmware of the nodes, and the like.

The MoCA device discovery software module is intended to perform the following functions for the MoCA device with which it is associated:
Periodically send out the node's information by specified Type Length Values (TLVs) via multicast Ethernet packets;
Respond to query requests by TLVs, by returning the IP address of the link-layer bridge to the requesting nodes node's specified ID;
Dynamically turn on or off the protocol of the link-layer bridge via a configuration parameter;
Transmit the TLV of the link-layer bridge after the MoCA link is up;
Give the network devices' MAC address by TLVs to those link-layer bridges that are connected with the node directly via Ethernet ports.

In operation, a MoCA device discovery protocol host software module is contained in a management network device, such as an STB or a PC connected in the MoCA network. The software module polls the information of the MoCA device by decoding its TLVs in the push mode. The software module also can send out a request TLV to retrieve a specified node's information. The request can be, for example, “retrieve the IP/MAC address for a given node ID,” or “retrieve a node ID by giving the MAC address,” or the like, in a pull mode.

In general, currently MoCA nodes do not store all of the information pertaining to other MoCA nodes. Consequently, users cannot presently perform the network discovery by MoCA commands. Any particular MoCA node only has the capability to report its own information. The MoCA network, however, has a capability to broadcast the MoCA device discovery protocol packets to all of the MoCA nodes, and all of the MoCA nodes forward these packets to its respective Ethernet port. It should be noted, however, that future implementations may have a capability to store information pertaining to other MoCA nodes. If the MoCA devices have such information storing ability, it may be possible for users to retrieve the information using MoCA commands.

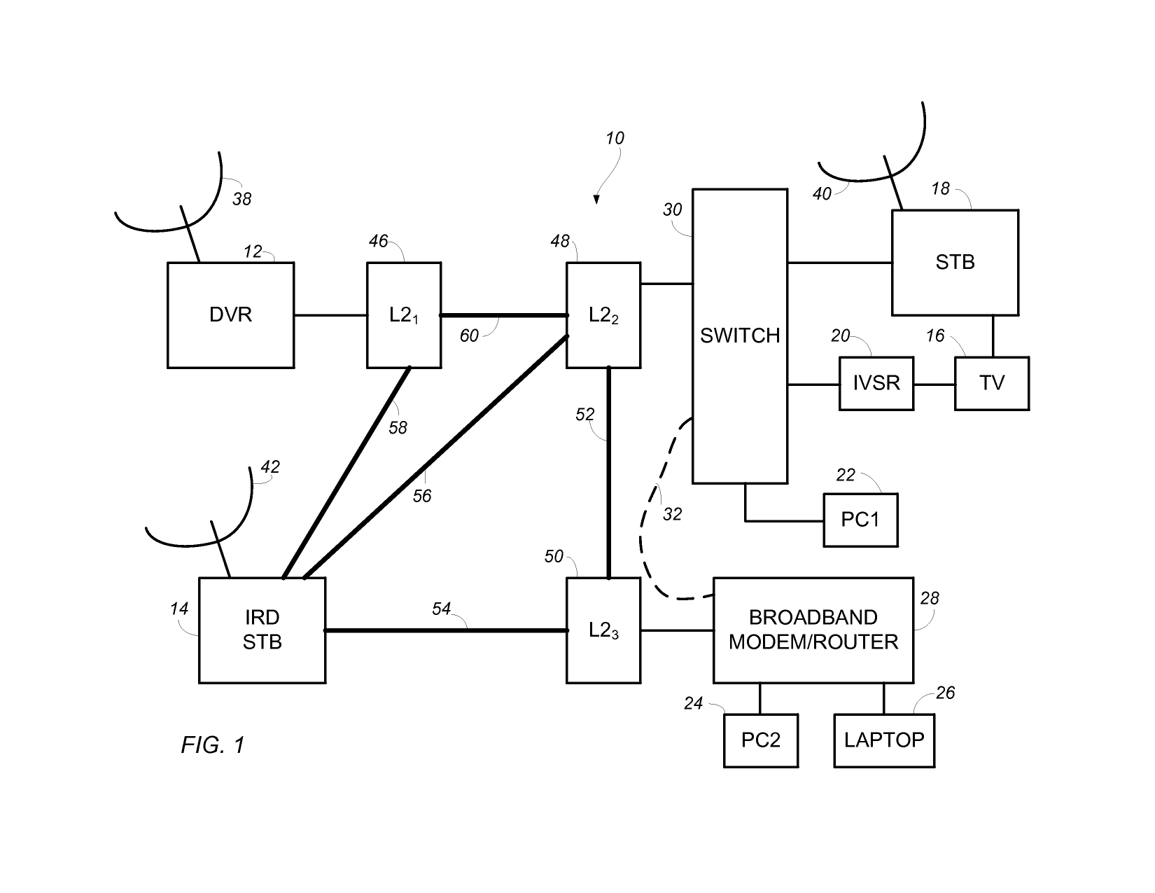

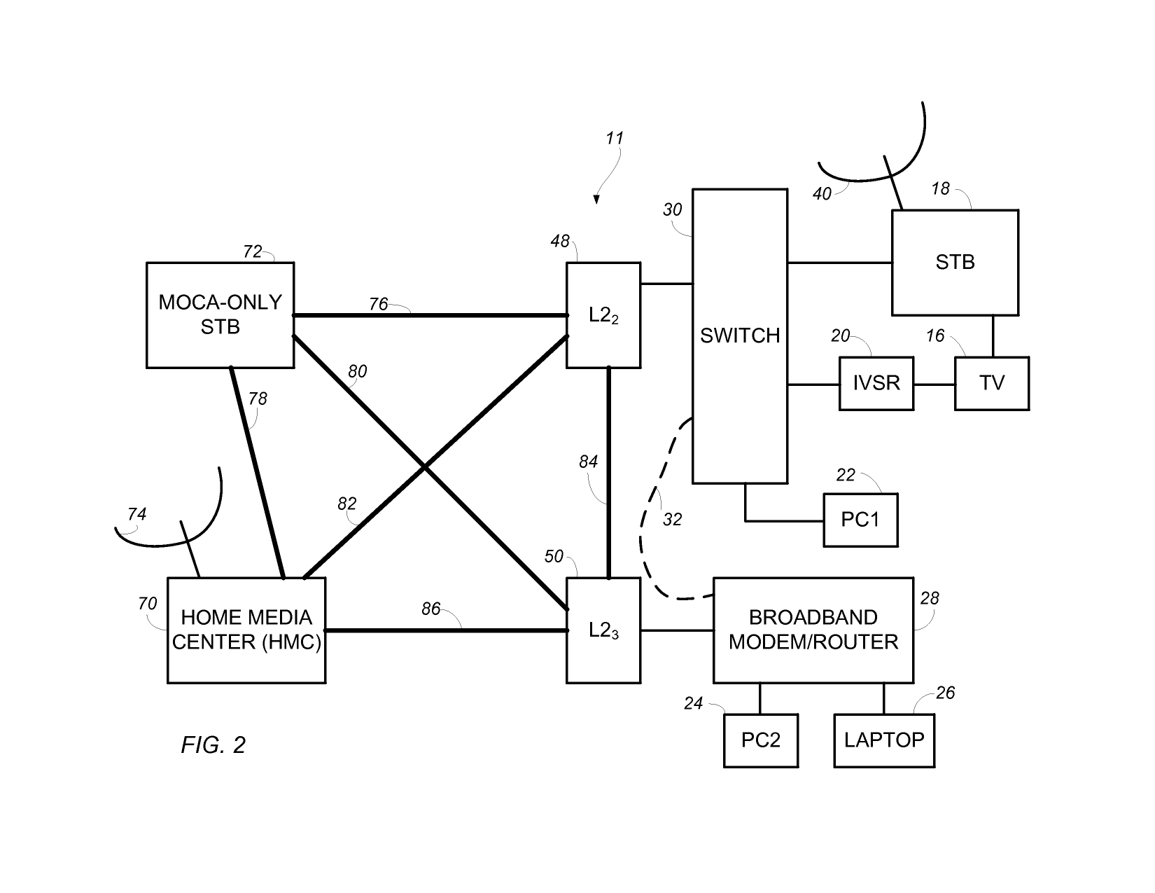

It should also be noted that in general, an L2 bridge currently has two interfaces: an Ethernet interface and a MoCA interface. In performing a discovery process, an L2 bridge pushes a discovery message onto both interfaces. In the future, however, an L2 bridge may have multiple interfaces, and the bridge will send out discovery messages on all available and active interfaces. For example in FIG. 1, bridge L2₁ 46 will send discovery messages towards the other L2 bridges connected to it via the MoCA interface as well as to the DVR 12 that is connected to it via the Ethernet interface, and so on.

While various embodiments of the disclosed method and apparatus have been described above, it should be understood that they have been presented by way of example only, and should not limit the claimed invention. Likewise, the various diagrams may depict an example architectural or other configuration for the disclosed method and apparatus. This is done to aid in understanding the features and functionality that can be included in the disclosed method and apparatus. The claimed invention is not restricted to the illustrated example architectures or configurations, rather the desired features can be implemented using a variety of alternative architectures and configurations. Indeed, it will be apparent to one of skill in the art how alternative functional, logical or physical partitioning and configurations can be implemented to implement the desired features of the disclosed method and apparatus. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It may be possible to extend the disclosed protocol to implement complete management functions of link-layer bridge operations, although it may not provide the most reliable communications. Using TCP/IP protocols with a known IP address may be more reliable, since retransmissions are built-in, and reliability is important for software upgrades.

Although the disclosed method and apparatus is described above in terms of various exemplary embodiments and implementations, it should be understood that the various features, aspects and functionality described in one or more of the individual embodiments are not limited in their applicability to the particular embodiment with which they are described. Thus, the breadth and scope of the claimed invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of discovering information about a first MoCA device in a MoCA network, comprising:
causing the first MoCA device to periodically send the information to at least a second MoCA device in the MoCA network; and
causing the second MoCA device to receive the information.

2. The method of claim 1 wherein said causing the first MoCA device to periodically send the information comprises sending the information via a link-layer discovery protocol (LLDP) message.

3. The method of claim 2 wherein said causing the first MoCA device to periodically send the information comprises encoding the information in a type-length value (TLV) message and sending said TLV message in the link-layer discovery protocol (LLDP) message.

4. The method of claim 1 wherein said causing the first MoCA device to periodically send the information comprises causing the first MoCA device to send the information about every 60 seconds.

5. The method of claim 1 wherein said causing the first MoCA device to periodically send the information comprises causing the first MoCA device to send its own MAC address.

6. The method of claim 1 wherein said causing the first MoCA device to periodically send the information comprises causing the first MoCA device to send its own IP address.

7. The method of claim 1 wherein said causing the first MoCA device to periodically send the information comprises causing the first MoCA device to send vendor identification information of the first MoCA device.

8. The method of claim 1 wherein said causing the first MoCA device to periodically send the information comprises causing the first MoCA device to send hardware identification information of the first MoCA device.

9. The method of claim 1 wherein said causing the first MoCA device to periodically send the information comprises causing the first MoCA device to send hardware version information of the first MoCA device.

10. The method of claim 1 wherein said causing the first MoCA device to periodically send the information comprises causing the first MoCA device to send software identification information of the first MoCA device.

11. The method of claim 1 wherein said causing the first MoCA device to periodically send the information comprises causing the first MoCA device to send a software version of the first MoCA device.

12. The method of claim 1 wherein said causing the first MoCA device to periodically send the information comprises causing the first MoCA device to send a name of the first MoCA device.

13. The method of claim 1 wherein said causing the first MoCA device to periodically send the information comprises causing the first MoCA device to send a location of the first MoCA device.

14. The method of claim 1 wherein said causing the first MoCA device to periodically send the information comprises causing the first MoCA device to send an identification of a MoCA node assigned to the first MoCA device.

15. A computer program product, comprising a computer usable medium having a computer readable program code embodied therein, said computer readable program code adapted to be executed to implement a method for discovering information about a first MoCA node, said method comprising;
a) determining a time period;
b) at the expiration of the time period, causing the first MoCA node to send device specific information about the first MoCA device to at least a second MoCA device in a MoCA network containing the first and second MoCA devices;
c) and repeating steps a) and b).

16. The computer program product of claim 15 wherein said determining a time period comprises determining a time period of about 60 seconds.

17. The computer program product of claim 15 wherein said causing the first MoCA device to send device specific information comprises causing the first MoCA device to send its own MAC address.

18. The computer program product of claim 15 wherein said causing the first MoCA device to send device specific information comprises causing the first MoCA device to send its own IP address.

19. The computer program product of claim 15 wherein said causing the first MoCA device to send device specific information comprises causing the first MoCA device to send vendor identification information of the first MoCA device.

20. The computer program product of claim 15 wherein said causing the first MoCA device to send device specific information comprises causing the first MoCA device to send hardware identification information of the first MoCA device.

21. The computer program product of claim 15 wherein said causing the first MoCA device to send device specific information comprises causing the first MoCA device to hardware version information of the first MoCA device.

22. The computer program product of claim 15 wherein said causing the first MoCA device to send device specific information comprises causing the first MoCA device to send software identification information of the first MoCA device.

23. The computer program product of claim 15 wherein said causing the first MoCA device to send device specific information comprises causing the first MoCA device to send a software version of the first MoCA device.

24. The computer program product of claim 15 wherein said causing the first MoCA device to send device specific information comprises causing the first MoCA device to send a name of the first MoCA device.

25. The computer program product of claim 15 wherein said causing the first MoCA device to send device specific information comprises causing the first MoCA device to send a location of the first MoCA device.

26. The computer program product of claim 15 wherein said causing the first MoCA device to send device specific information comprises causing the first MoCA device to send an identification of a MoCA node assigned to the first MoCA device.

27. A network, comprising:
a plurality of MoCA devices, at least some of the MoCA devices being adapted to be connected to respective network devices;
an link-layer discovery protocol (LLDP) agent associated with one of the plurality of network devices;
a management database;
wherein said plurality of MoCA devices each periodically sends device specific information to the LLDP agent, and wherein the LLDP agent causes the information sent by the plurality of MoCA devices to be stored in the management database, whereby information of any of the plurality of MoCA nodes can be discovered from the information in the management database.

28. The network of claim 27 wherein the information is sent periodically about every 60 seconds.

29. The network of claim 27 wherein the information is encoded in a type-length value (TLV) message in an LLDP message sent to the LLDP agent.

30. The network of claim 27 wherein the information comprises a MAC address.

31. The network of claim 27 wherein the information comprises an IP address.

32. The network of claim 27 wherein the information comprises vendor identification information.

33. The network of claim 27 wherein the information comprises hardware identification information.

34. The network of claim 27 wherein the information comprises hardware version information.

35. The network of claim 27 wherein the information comprises software identification information.

36. The network of claim 27 wherein the information comprises software version information.

37. The network of claim 27 wherein the information comprises a MoCA device name.

38. The network of claim 27 wherein the information comprises a MoCA device location.

39. The network of claim 27 wherein the information comprises an identification of a MoCA node assigned to a respective MoCA network device.

40. The network of claim 27 wherein plurality of MoCA devices, the respective network devices, and the LLDP agent comprise a home network environment.

41. A MoCA node discovery process, comprising:
a) determining whether a MoCA node has been linked into a MoCA network;
b) determining whether the MoCA node is linked into the MoCA network for the first time;
c) if the determination is that the MoCA node is linked into the network for the first time, setting a time-to-live (TTL) value to zero;
d) if the determination is that the MoCA node is not linked into the network for the first time, determining whether a 60-second timer has expired;
e) if the determination is that the 60-second timer has not expired, repeating steps a)-d);
f) if the determination is that the 60-second timer has expired, reset the 60 second timer and encode and send a link-layer discovery protocol data unit (LLDPDU) containing device specific information about the MoCA node.

42. A home entertainment system, comprising:
a plurality of MoCA devices;
a plurality of network devices connected to a respective at least some of the MoCA devices;
a link-layer discovery protocol (LLDP) agent on one of the network devices with which the MoCA devices communicate;
a management database;
wherein the LLDP causes device specific information about the MoCA devices to be stored in the management database, whereby information of any of the plurality of MoCA devices can be discovered from the information in the management database.

43. The home entertainment system of claim 42 wherein the MoCA nodes push the information to the management database.

44. The home entertainment system of claim 36 wherein the MoCA nodes pull at least some of the information from the management database.
